(19) United States
(12) Patent Application Publication
(10) Pub. No.: US 2010/0293017 A1
(43) Pub. Date: Nov. 18, 2010

(54) MICROPAYMENT AND WEBSITE CONTENT CONTROL SYSTEMS AND METHODS

(75) Inventors: NOAH MERRITT, MILWAUKIE, OR (US); SEAN HAMMONS, MILWAUKIE, OR (US); ALEX WILHELM, MILWAUKIE, OR (US)

Correspondence Address: MARGER JOHNSON & MCCOLLOM, P.C., 210 SW MORRISON STREET, SUITE 400, PORTLAND, OR, 97204, US

(73) Assignee: CONTENTURE, INC., MILWAUKIE, OR (US)

(21) Appl. No.: 12/472,272

(22) Filed: May 26, 2009

Related U.S. Application Data
(60) Provisional application No. 61/179,261, filed on May 18, 2009.

(51) Int. Cl. G06Q 20/00; G06Q 10/00; G06Q 40/00; H04L 9/32

(52) U.S. Cl. 705/7; 705/40; 726/4

(57) ABSTRACT

An online monetization system can include a website registration module, a user registration module, a user billing module, a website monitoring module, and a micropayment determination module. The system can also include a micropayment processing module and, in some embodiments, a website content configuration module.

### CROSS-REFERENCE TO RELATED APPLICATIONS

This application claims the benefit of U.S. Provisional Patent Application Ser. No. 61/179,261, titled “AUTOMATED ONLINE MONETIZATION MICROPAYMENT SYSTEMS AND METHODS,” filed on May 18, 2009, which is hereby incorporated by reference in its entirety herein.

### TECHNICAL FIELD

The disclosed technology pertains to online monetization systems, and more particularly to systems and methods that involve micropayment and content control mechanisms.

### BACKGROUND

Many Internet users currently believe that the Internet as presently known is virtually unsustainable because, for example, advertising revenues for websites and web services are consistently poor unless the sites or services are particularly well-known. Even well-known websites, however, often need to deal with advertising revenues that are less than solid. Also, while advertising revenues have never been very good, the last few years have been especially harsh.

Many websites are struggling to make the money they need to stay alive. In fact, many website and web service operators continue to go out of business due to a failure of the advertising revenues, which typically constitute the vast majority of income for the sites and services, to even cover the operating costs of the servers that are running the sites and services.

Over the past several years, online micropayment systems have been developed as a way to increase revenues for websites and web services. As used herein, a micropayment generally refers to a relatively small payment having an amount that is typically no more than five or ten dollars.

Current micropayment systems typically involve user accounts that are funded via credit card transactions, wire transfers, Paypal payments, etc. When a user visits a website that accepts micropayments, the user is generally presented with an option to send a micropayment to the website where the micropayment is taken directly from the user's account.

While the increased use of online micropayment systems has helped, however, current micropayment systems have a number of significant shortcomings and drawbacks. For example, users of current micropayment systems typically need to authorize each and every payment the user desires to make. This experience is usually quite cumbersome and, as a result, the users often become annoyed with the process and decide to forego sending micropayments to participating websites.

### SUMMARY

Embodiments of the disclosed technology can include advantageous techniques for monetizing a website. In certain implementations, a website can make money for each visit to the website by a registered user. For example, such users can pay a set fee on a monthly basis. The system can then automatically distribute a portion of the fees paid by a user to websites that the user visits during a certain period of time. Thus, users are directly supporting the websites with which they actually interact.

The system can determine the amount of money to be sent to a particular website based on the number of times that the user visited the website. In certain embodiments, the system can weigh the number of visits that the user made to the particular website against the number of visits the user made to other websites during the same period of time. For example, if the user visited the particular website ten times and visited other websites five times during the period in question, the system can distribute two-thirds of the funds collected from the user to the particular website.

In certain embodiments, the system can provide a participating website with an ability to add certain features to the website for registered users. For example, the system can enable a website to provide registered users with certain “microservices” such as priority access to new articles, exclusive access to archives, and commenting privileges. The system can also enable the website to provide the user with an ad-free experience. Thus, whereas current systems tend to focus on restricting free users, embodiments of the disclosed technology can advantageously focus on rewarding supporters of participating websites.

The disclosed technology can be implemented in connection with virtually any type of web site. One having ordinary skill in the art will recognize that, while certain embodiments are primarily designed for content-based websites, other embodiments can be geared toward service-oriented or other types of websites as well.

### BRIEF DESCRIPTION OF THE DRAWINGS

FIG. 1 is a block diagram illustrating a prior art system including multiple users visiting a particular website.

FIG. 2 is a block diagram illustrating an example of an online micropayment and content control system in accordance with certain implementations of the disclosed technology.

FIG. 3 is a block diagram illustrating a detailed example of an online micropayment and content control system in accordance with certain implementations of the disclosed technology.

FIG. 4 is a flowchart illustrating an example of a machine-controlled method of handling micropayments and content control mechanisms in accordance with certain implementations of the disclosed technology.

### DETAILED DESCRIPTION

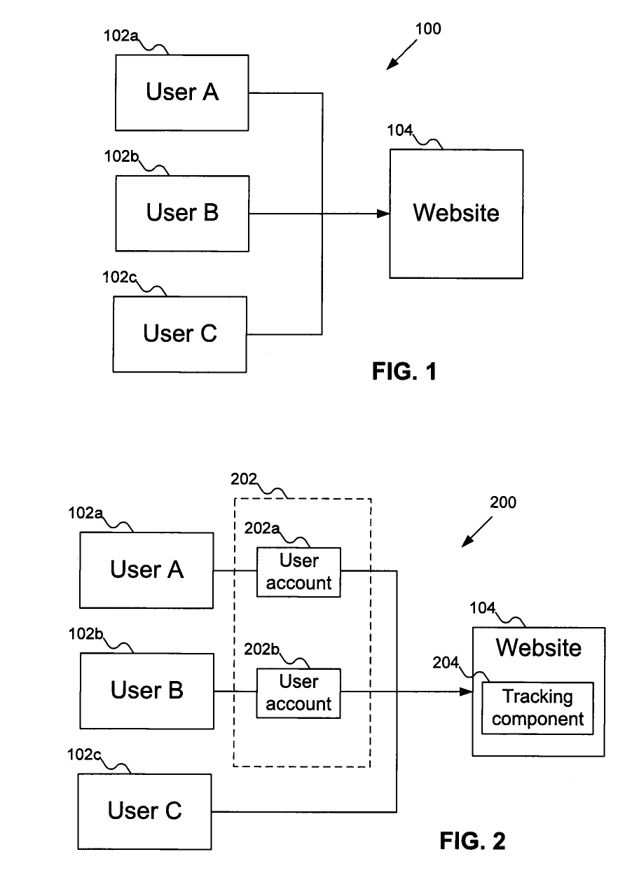

FIG. 1 is a block diagram illustrating a prior art system 100 in which multiple users 102a-102c are each interacting with a particular website 104. As used herein, an interaction between a website and a user can include a visit by the user to a page within the website, a transaction performed by the user at the website, or some other user action that involves the website in a recognizable manner.

FIG. 2 is a block diagram illustrating an example of an online micropayment and content control system 200. In the example, two users 102a and 102b have user account 202a and 202b, respectively, within a sub-system 202 of the online micropayment and content control system 200. A user registration module (not shown) can be used to enable the users 102a and 102b to create the user accounts 202a and 202b, respectively.

In the example, the website 104 includes a tracking component 204. The tracking component can include JavaScript code that can be used to identify whether each of the visiting users 102a-102c has a user account associated with the sub-system 200. In the example, the tracking component 204 can determine that the first two users 102a and 102b have user accounts 202a and 202b, respectively, whereas the third user 102c does not have a user account associated with the sub-system 200. The tracking component 204 can send information pertaining to the visit by each of the first two users 102a and 102b to the website to a central database or some other type of data repository (not shown).

Thus, the tracking component 204 advantageously enables the online micropayment and content control system 200 to automatically monitor when registered users visit a participating website. For each registered user, the online micropayment and content control system 200 can log each unique visit the user makes to each participating website and can then use that traffic to automatically determine how much money each website earns from that visitor every month, for example.

A Detailed Example of a Micropayment and Content Control System in Accordance with Implementations of the Disclosed Technology

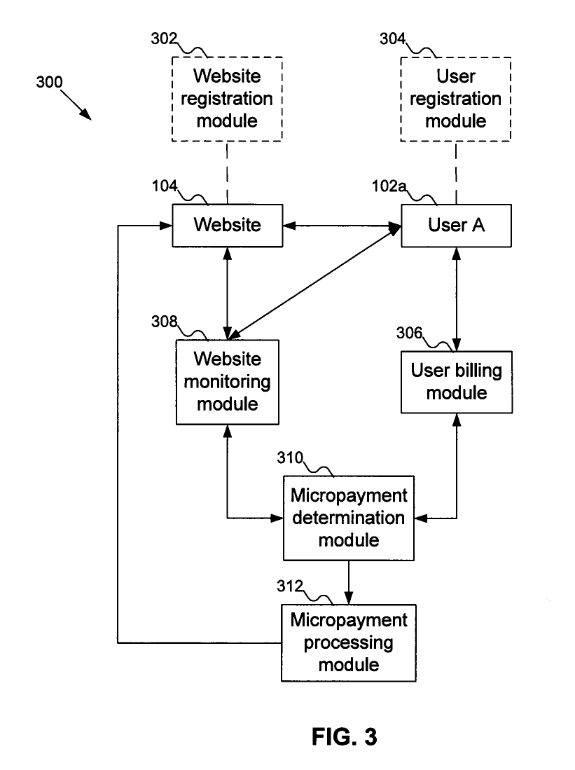

FIG. 3 is a block diagram illustrating a detailed example of an online micropayment and content control system 300. A website registration module 302 can provide the website 104 with the ability to register itself directly with the micropayment and content control system 300. For example, the website registration module 302 can provide the website 104 with a tracking component (not shown) that can be used to facilitate tracking of interactions between the website 104 and the user 102a.

A user registration module 304 can provide the user 102a with the ability to register himself or herself directly with the micropayment and content control system 300. For example, the user registration module 304 can create a new user account (not shown) associated with the micropayment and content control system 300 for the user 102a. In certain embodiments, the user 102a can use the user registration module 304 to modify or delete the user's account. The user registration module 304 can also be used to disable the user's 102a account for any of a number of reasons.

In the example, a user billing module 306 can collect a payment from the user 102a via a credit card, a PayPal account, or virtually any other type of typical funding means. The user billing module 306 can collect payments from the user on a recurring (e.g., monthly) basis. In certain embodiments, each payment is a specific, predetermined amount. Alternatively, the payments can fluctuate based on virtually any number of factors that can impact the payments.

A website monitoring module 308 can track interactions between the website 104 and the user 102a. For example, the website monitoring module 308 can receive information from a tracking component (not shown) associated with the website 104. Such information can include the user 102a's ID, the user machine's IP address, the website 104's ID, and a URL for the specific page(s) within the website 104 that the user 102a interacted with during the same visit. The website monitoring module 308 can also store the received information, either locally or at a remote data repository such as a database (not shown).

In the example, a micropayment determination module 310 can evaluate the information received by the website monitoring module 308 in order to determine the amount of a micropayment to be sent to the website 104 from the user 102a. For example, the greater the number of interactions between the website 104 and the user 102a over a specified period of time, the greater the amount of the micropayment from the user 102a to the website.

Alternatively, the greater the amount of time that the user 102a spent at the website 104 over the same period of time, the greater the amount of the micropayment. One having ordinary skill in the art will appreciate that there are many different ways to determine a micropayment amount based on user interactions with a website.

Once the micropayment determination module 310 has determined a micropayment amount, a micropayment processing module 312 can send the micropayment to the website 104. In certain embodiments, the micropayment processing module 312 can automatically send the micropayment to the website 104 immediately upon the determination of the micropayment amount by the micropayment determination module 310.

The micropayment processing module 312 can take any of a number of factors into account when determining whether to send the micropayment to the website 104. For example, the micropayment processing module 312 can be configured to automatically send the micropayment to the website 104 when the accumulated micropayment has exceeded a certain threshold amount.

In embodiments where the micropayment processing module 312 withdraws the amount of the micropayment directly from the user 102a's account, the micropayment processing module 312 can place a hold on sending the micropayment to the website 104 if the user 102a's account does not have sufficient funds to cover the micropayment amount.

Date and/or time can be a factor to be taken into account by both the micropayment determination module 310 and the micropayment processing module 312. For example, the micropayment determination module 310 and the micropayment processing module 312 can be configured to automatically determine and send, respectively, a micropayment to the website 104 on a recurring basis (e.g., on the first day of each month or at the end of each fiscal quarter).

In certain embodiments, the website 104 can include a website content control module (not shown) that can be used to automatically configure the website 104 in response to a determination that the user 102a is a registered user. For example, the website can provide different levels of content accessibility for registered users versus non-registered users, such as access to exclusive content or blocking of advertisements.

In certain embodiments, the website 104 can provide additional privileges to a registered user 102a based on the total number of interactions between the website 104 and the user 102a. Generally speaking, the greater the number of interactions between the website 104 and the user 102a, the greater the number and/or extent of privileges provided by the website 104 to the user 102a. For example, the website 104 can provide ad-blocking for all registered users but only provide access to certain privileged content on the website 104 when the user 102a has visited the website 104 a certain number of times or has spent a certain amount of time at the website 104.

In certain embodiments, a website content control module can include JavaScript functions that are pre-programmed into a tracking component (not shown) that is incorporated into the website 104. The JavaScript functions can also enable the website 104 to easily manipulate the content on the website for registered [versus non-registered] users.

Example Implementations that Include the Use of a User Authentication API

In order to prevent users from potentially manipulating the JavaScript to view content that is supposed to be hidden from them, for example, a backend user authentication API can be called from the website 104 to verify that the user is indeed a registered user. The user authentication API can also enable the website 104 to incorporate content controls internally.

In situations where the website 104 has user accounts, the system need only ask for each user's API authentication key once. The system can then store each key in a database and check the database each time the user logs into the website 104 in the future. Thus, the user does not need to remember his or her authentication key, let alone enter it into the system each time he or she logs in.

If the website 104 does not have a user account system, the website 104 can store the user authentication key in a cookie and use that to call the API each time the user returns to the website 104. The user authentication key can also be displayed on the user's homepage.

An Example of a Machine-Controlled Method in Accordance with Implementations of the Disclosed Technology

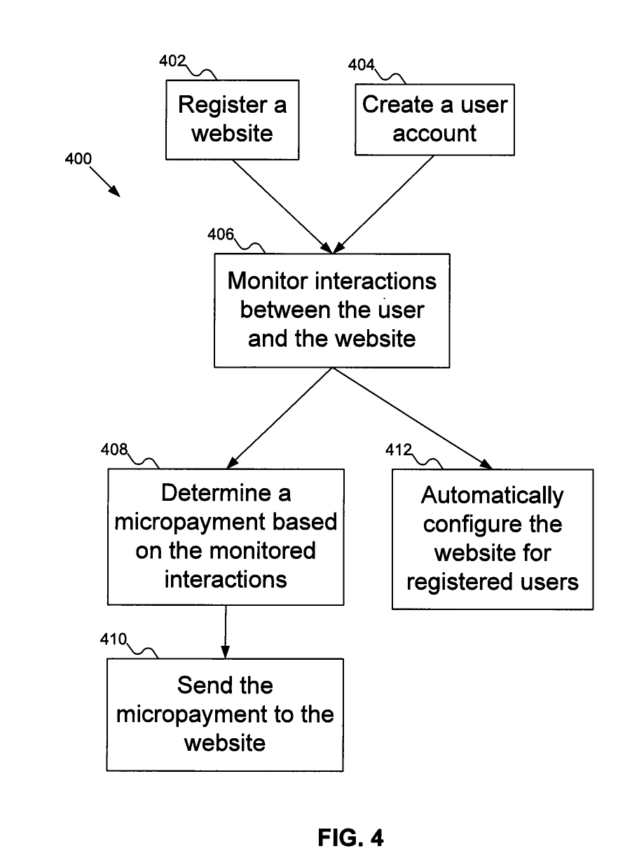

FIG. 4 is a flowchart illustrating an example of a machine-controlled method 400 in accordance with certain implementations of the disclosed technology.

At 402, a website can be registered with the system. For example, the website may associate therewith a tracking component such as a JavaScript utility that can be used for various website tracking purposes.

In certain embodiments, website registration can include a copy and paste of a few lines of JavaScript that can be retrieved from a user homepage, for example. In situations where a website operator is installing the JavaScript code manually on the website, the operator can place the code at the bottom (e.g., right before the </body>tag) so that it is the last item to load. This can advantageously ensure that the website remains as quick-loading as possible. Below is an example of the JavaScript code that can be copied and pasted into the website:

```
<script src=“http://t.contenture.com/t.js”
type=“text/javascript”></script>
<script type=“text/javascript”>
  <!-- All customizations MUST go between this line and the “init”
line below. -->
  _ctr.init( ‘your_site_id’, ‘your_db_server’ );
</script>
</body>
```

The tracking component is generally compatible with secure websites. For example, the tracking code pasted into the website can automatically detect when a page is secured. In such cases, the tracking component can use a secure connection with the system server(s).

At 404, a user account can be created. For example, a user can provide the system with personal information, such as identity, and payment information, such as a credit card number or PayPal account identification information. The system can periodically bill the user (not shown) and associate the collected amount with the user's account.

In certain embodiments, the system can charge a website-specific fee on top of a user's normal fee. For example, if a website wants to guarantee a collection of $1.00 per user per month, then the system can charge a base level user that currently pays $5.99 per month $6.99 per month instead. The additional $1.00 would thus go to the website and the remaining $5.99 would be split up among all of the other participating websites that the user visited that month.

At 406, interactions between the website and the user can be monitored. For example, each time the user visits the website, the website can first determine that the user is a registered user via the tracking component. The website can then send information pertaining to the interaction to a local or remote storage module such as a database.

The information collected and sent by the website can include any of a number of different types of pertinent information such as user identification information, the user's IP address, the user's ID, the website's IP address, the website's ID, the URL address(es) of the page(s) within the website visited by the user, and the amount of total time that the user spent at the website during the tracked visits, for example.

At 408, the system determines a micropayment amount based on the monitored interactions between the website and the user. For example, system may determine a micropayment amount that is directly proportional to the number of visits the user paid to the website or to the amount of time the user spent at the website.

At 410, the system can send the micropayment to the website. In certain embodiments, the system sends the micropayment immediately upon the determination of the micropayment amount at 408. Alternatively, the system can hold off on sending the micropayment to the website until a specified date or event such as a threshold amount being exceeded. The micropayment can be sent via Paypal or via paper check, for example.

At 412, the website can automatically configure itself in response to a determination that the visiting user is a registered user. For example, each time a user visits the website, the website can first determine whether the user is a registered user by way of a function _ctr.is_user( ) that returns a certain value if the user is registered and a different value if the user is not registered. If the website would like to block advertisements for each registered user that visits the website, for example, the website can implement the following function upon determining that the user is a registered user:

if(_ctr.is_user( ))_ctr.hide_ads( );

The website can configure itself in a number of different ways. For example, the website can provide the user with access to otherwise restricted content on the website. The website can also provide the user with certain privileges such as commenting abilities.
Examples of Hiding Content from Certain Users on a Website

In certain embodiments, a website can hide content from a user with a function _ctr.hide( ). For example, the function _ctr.hide( ) can be a part of a tracking component that is incorporated into the website. In the example, the input to the function can include either an ID or a class using standard “#id” and “.class” style syntax.

In situations where a visiting user has Javascript disabled, the system can designate the hidden content as “hidden” by default within the actual HTML and then change the designation of the hidden content to “visible” for the registered users.

The following is an example of a function that the website can implemented to hide the comment form for non-registered users in order to reduce spam and trolling, for example:

_ctr.hide(‘#commentform’);

The following is an example of a function that can be used by the website to hide the comment form by default and then make the comment form visible to registered users:

<form id=commentform style=“display:none;”>
...
_ctr.show(‘#commentform’);

The following is an example of a function that can be used by the website to reward registered users by hiding advertisements from their view when they visit the website:

_ctr.hide_ads( );
_ctr.hide(‘.my-text-ads’);

In certain embodiments, the _ctr.hide_ads( )function can be used to hide many of the common ad platforms running on the Internet and automatically hide other logical IDs and classes such as “ad,” “ads,” and “advertisements.” The function _ctr.hide( ) can also be used for elements that are not hidden automatically.
Examples of Providing Certain Users with Priority Access to New Content on a Participating Website

In certain embodiments, a website can reward registered users by providing them with priority access to new content such as articles on the website before non-registered users are allowed to see them.

In certain embodiments, a determination can be made as to how old an article should be before non-registered users can be allowed to see it. In such embodiments, the website can specify _ctr.priority_age, whose value represents how old (e.g., as measure in seconds) an article must be for the system to allow non-registered users to see it.

In certain embodiments, a function _ctr.priority_content (element, unixtime, message) can be applied to determine the actual age of a particular document, where the function takes the following arguments:

Element (required)—the system can pass in either an #id or a .class. Many platforms output a <div> element with an ID that matches the ID for the article in the database (e.g. <div id=123>). The website can use #ids to ensure that each specified element matches only one item.

Unixtime (required)—this is the Unix time when the article was posted. The system database may not store this value and instead store the time of posting in a “normal” date format such as “May 15, 2009 08:30:00.” Many languages have functions for converting a date string into a unixtime value. For example, with PHP, the system can send a particular string directly into strtotime( ), which can be used to return the appropriate unixtime value. For the example date above, the unixtime would be 1242401400.

Message (optional)—in situations where the system simply hides the content by default, the system can provide a message explaining to the user why the content is hidden. With this parameter, the system can specify the message on a per-item basis. The system can also set a global message that can be used for all hidden priority_content. This variable is _ctr.priority_message. In situations where the global message is set and the system passes in a custom message to the function, the custom message will generally take precedence.

The following is an example of a implementation incorporating the features discussed immediately above:

```
<script src=“http://t.contenture.com/t.js”
type=“text/javascript”></script>
<script type=“text/javascript”>
  <!-- All customizations MUST go between this line and the “init”
line below. -->
  _ctr.priority_age = 3600; // 1 hour
  _ctr.priority_message = “Please sign up for Contenture [link] to
access breaking news!”;
  _ctr.priority_content(‘#newest-story’, 1242401400);
  _ctr.priority_content(‘#2nd-newest-story’, 1242400400, ‘Custom
message for this story’);
  _ctr.init( ‘your_site_id’, ‘your_db_server’ );
</script>
</body>
```

Examples of Providing Certain Users with Exclusive Access to Content on the Website

In certain embodiments, a website can provide exclusive access to certain content on the website for registered users. There are at least two different ways to accomplish this. One way is to output a variable _ctr.required=1 on any page to which the website wishes to restrict access. Thus, when the variable _ctr.required=1 is present, the website can prevent the user from viewing the page unless the user is a registered user. The following is an example in which the variable _ctr.required=1 is present:

```
<script src=“http://t.contenture.com/t.js”
type=“text/javascript”></script>
<script type=“text/javascript”>
  <!-- All customizations MUST go between this line and the “init”
line below. -->
  _ctr.required = 1;
  _ctr.init( ‘your_site_id’, ‘your_db_server’ );
</script>
</body>
```

Another way of providing exclusive access to registered members involves the use of URL matching. For example, the website can limit access to articles in the /archives/ sub-directory for registered users only. To do this, the system can call a _ctr.filter( ) function for each page that the website wishes to restrict. In certain embodiments, the system can leave the domain name out of the filters and simply specify the unique part of the path and/or query that specifies the content.

In certain embodiments, because the code that checks strings uses regular expressions, some of the following filters can be used:

```
_ctr.filter( string, no_escape )
<script src=“http://t.contenture.com/t.js”
type=“text/javascript”></script>
<script type=“text/javascript”>
  <!-- All customizations MUST go between this line and the “init”
line below. -->
  // everything in the /archives/ directory
  _ctr.filter(“/archives/”);
  // just the archives index page. requests for actual articles
  // (e.g. someone landing from a search engine) will still work.
  _ctr.filter(“/archives/$”);
  // complex expression with manual escaping
  // note that you must use a double backslash for each escaped
character
  _ctr.filter(“\\/archives\\/(index.php)\\?”, 1 );
  // content created before Jan 1 2009
  _ctr.filter(“/200[0-8]/”);
  _ctr.init( ‘your_site_id’, ‘your_db_server’ );
</script>
</body>
```

### An Example of a Case Study

When it comes to interacting with websites, most users have their comfort sites—a group of perhaps 5-20 web sites—that they visit on a regular basis. Such comfort sites often represent up to 80% or 90% of the users' time online. Because a website generally only receives money from a user if the user visits that site, most of each user's money will be going to this small group of sites they regularly visit.

Consider an example in which user X has 10 comfort sites that he spends 80% of his time browsing. Thus, 80% of the money that the user pays every month (e.g., $8.00 out of $9.99) is going to these 10 sites, which works out to an average of 80 cents per site from one user. While some sites would be lucky to make this much money total from an entire month of advertising, websites implementation the techniques described herein can advantageously collect that amount from one user.

If the website in the example has 10,000 monthly visitors, of which 1,000 are registered users, the website can collect up to $800 revenue per month. In contrast, the same website would likely make no more than $20 to $50 per month from advertising revenue. Thus, while registered users need only pay small amounts, the registered websites can realize a significant increase in revenue.

General Description of a Suitable Machine in which Embodiments of the Disclosed Technology can be Implemented

The following discussion is intended to provide a brief, general description of a suitable machine in which embodiments of the disclosed technology can be implemented. As used herein, the term “machine” is intended to broadly encompass a single machine or a system of communicatively coupled machines or devices operating together. Exemplary machines can include computing devices such as personal computers, workstations, servers, portable computers, handheld devices, tablet devices, and the like.

Typically, a machine includes a system bus to which processors, memory (e.g., random access memory (RAM), read-only memory (ROM), and other state-preserving medium), storage devices, a video interface, and input/output interface ports can be attached. The machine can also include embedded controllers such as programmable or non-programmable logic devices or arrays, Application Specific Integrated Circuits, embedded computers, smart cards, and the like. The machine can be controlled, at least in part, by input from conventional input devices (e.g., keyboards and mice), as well as by directives received from another machine, interaction with a virtual reality (VR) environment, biometric feedback, or other input signal.

The machine can utilize one or more connections to one or more remote machines, such as through a network interface, modem, or other communicative coupling. Machines can be interconnected by way of a physical and/or logical network, such as an intranet, the Internet, local area networks, wide area networks, etc. One having ordinary skill in the art will appreciate that network communication can utilize various wired and/or wireless short range or long range carriers and protocols, including radio frequency (RF), satellite, microwave, Institute of Electrical and Electronics Engineers (IEEE) 545.11, Bluetooth, optical, infrared, cable, laser, etc.

Embodiments of the disclosed technology can be described by reference to or in conjunction with associated data including functions, procedures, data structures, application programs, instructions, etc. that, when accessed by a machine, can result in the machine performing tasks or defining abstract data types or low-level hardware contexts. Associated data can be stored in, for example, volatile and/or non-volatile memory (e.g., RAM and ROM) or in other storage devices and their associated storage media, which can include hard-drives, floppy-disks, optical storage, tapes, flash memory, memory sticks, digital video disks, biological storage, and other tangible, physical storage media.

Associated data can be delivered over transmission environments, including the physical and/or logical network, in the form of packets, serial data, parallel data, propagated signals, etc., and can be used in a compressed or encrypted format. Associated data can be used in a distributed environment, and stored locally and/or remotely for machine access.

Having described and illustrated the principles of the invention with reference to illustrated embodiments, it will be recognized that the illustrated embodiments may be modified in arrangement and detail without departing from such principles, and may be combined in any desired manner. And although the foregoing discussion has focused on particular embodiments, other configurations are contemplated. In particular, even though expressions such as “according to an implementation of the disclosed technology” or the like are used herein, these phrases are meant to generally reference implementation or embodiment possibilities, and are not intended to limit the invention to particular embodiment configurations. As used herein, these terms may reference the same or different embodiments that are combinable into other embodiments.

Consequently, in view of the wide variety of permutations to the embodiments described herein, this detailed description and accompanying material is intended to be illustrative only, and should not be taken as limiting the scope of the invention. What is claimed as the invention, therefore, is all such modifications as may come within the scope and spirit of the following claims and equivalents thereto.

1. An online monetization system, comprising:
a website registration module operable to register a website with the online monetization system;
a user registration module operable to create a user account for a user with the online monetization system;
a user billing module operable to collect at least one payment from the user and to associate the at least one payment with the user account;
a website monitoring module operable to monitor interactions between the website and the user; and
a micropayment determination module operable to determine a micropayment to be sent to the website based at least in part on the monitored interactions between the website and the user.

2. The online monetization system of claim 1, further comprising a micropayment processing module operable to withdraw funds for the micropayment from the at least one payment and to send the micropayment to the website.

3. The online monetization system of claim 2, wherein the micropayment processing module is operable to automatically send the micropayment to the website upon completion of the determination of the micropayment.

4. The online monetization system of claim 1, wherein the at least one payment comprises a predetermined amount funded by the user.

5. The online monetization system of claim 1, wherein the user billing module is further operable to collect multiple payments from the user on a recurring basis.

6. The online monetization system of claim 1, wherein the monitored interactions comprise visits that the user made to the website over a specified period of time.

7. The online monetization system of claim 1, further comprising a website content configuration module operable to automatically configure at least one option associated with the website responsive to a request from the user.

8. The online monetization system of claim 7, wherein the at least one option pertains to removing advertisements from a view of the website.

9. The online monetization system of claim 7, wherein the at least one option pertains to the user accessing content on the website.

10. A machine-controlled method, comprising:
registering a website with an online monetization system;
creating a user account for a user with the online monetization system;
collecting at least one payment from the user to fund the user account;
tracking a number of interactions between the user and the website; and
determining a micropayment to be made to the website based on the number of interactions between the user and the website.

11. The machine-controlled method of claim 10, further comprising:
withdrawing funds for the micropayment from the user account; and
distributing the micropayment to the website.

12. The machine-controlled method of claim 11, wherein the withdrawing and distributing occur automatically when the micropayment exceeds a threshold amount.

13. The machine-controlled method of claim 11, wherein the withdrawing and distributing occur on a recurring basis.

14. The machine-controlled method of claim 10, wherein collecting the at least one payment from the user comprises collecting a predetermined amount on a recurring basis.

15. The machine-controlled method of claim 11, wherein the at least one payment comprises a first amount to be subject to the withdrawing and a second amount to be allocated directly to the website.

16. The machine-controlled method of claim 10, further comprising the website automatically configuring a view of the website responsive to a determination that the user is a registered user.

17. The machine-controlled method of claim 16, wherein the automatically configuring comprises at least one of providing the user with exclusive access to content on the website, providing the user with priority access to content on the website, providing the user with commenting privileges, and providing the user with participation privileges.

18. The machine-controlled method of claim 16, wherein the automatically configuring comprises removing advertisements from a view of the website.

19. The machine-controlled method of claim 10, wherein registering the website comprises incorporating a tracking component into the website.

20. The machine-controlled method of claim 19, wherein tracking the number of interactions comprises accessing the tracking component.

21. The machine-controlled method of claim 19, wherein incorporating the tracking component into the website comprises copying JavaScript code from another website and storing the copied JavaScript code at the website.

22. An apparatus, comprising:
a website association module operable to associate a website with an online monetization system;
a user registration module operable to create a user account with the online monetization system for a user;
a user billing module operable to collect at least one payment from the user and to associate the at least one payment with the user account;
a micropayment module operable to determine a micropayment based on a number of interactions between the user and the website and to send the micropayment to the website; and
a website content configuration module operable to automatically configure at least one option associated with the website responsive to a determination that the user is a registered user.
